(19) United States
(12) Patent Application Publication
(10) Pub. No.: US 2026/0093932 A1
(43) Pub. Date: Apr. 2, 2026

(54) SYSTEMS AND METHODS FOR PROVIDING SELF-IMPROVING ARTIFICIAL INTELLIGENCE MODELS

(71) Applicant: Salesforce, Inc., San Francisco, CA (US)

(72) Inventors: Xiangyu (Becky) Peng, Palo Alto, CA (US); Congying Xia, Chicago, IL (US); Xinyi Yang, Palo Alto, CA (US); Chien-Sheng (Jason) Wu, Mountain View, CA (US)

(21) Appl. No.: 19/038,405

(22) Filed: Jan. 27, 2025

Related U.S. Application Data
(60) Provisional application No. 63/700,649, filed on Sep. 28, 2024.

(51) Int. Cl. G06F 40/40; G06N 3/0475; G06N 3/08

(52) U.S. Cl. CPC G06F 40/40; G06N 3/0475; G06N 3/08

(57) ABSTRACT

Embodiments described herein provide a training framework for training a neural network-based language model. Under the training framework, multiple reasoning paths are generated using the neural network-based language model for solving a task request based on different task-agnostic reasoning guidelines representing different general problem-solving methodologies. Each of the reasoning paths includes step-by-step instructions for solving the specific task request using a different problem-solving methodology. The neural-network-based language model is trained based on training data that is generated using the different reasoning paths, such that the overall ability of the neural network-based language model for solving different types of problems can be improved.

### CROSS REFERENCE(S)

The instant application is a nonprovisional of and claim priority under 35 U.S.C. 119 to U.S. provisional application No. 63/700,649, filed Sep. 28, 2024, which is hereby expressly incorporated by reference herein in its entirety.

### TECHNICAL FIELD

The embodiments relate generally to machine learning systems for providing artificial intelligence-based conversation agents, and more specifically to providing self-improving artificial intelligence models.

### BACKGROUND

Artificial intelligence agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model (also referred to as “AI models”) to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

AI agents may also be instructed to generate reasoning along with an output answer. The reasoning may provide insights on how a specific answer is generated based on a specific question (e.g., a task request). Performing post-training (e.g., fine-tuning) to an AI agent with explicit instructions to adjust the reasoning used by AI agent can improve the performance of the AI agent. However, while existing solutions enable AI agents to be fine-tuned to generate correct reasoning, such fine-tuning is often limited to specific tasks, e.g., in-domain tasks. Specifically, existing fine-tuning approaches often use training data corresponding to a specific domain to train the AI agents to generate correct reasoning for performing tasks within the specific domain. Such domain-specific fine-tuning can be inefficient in improving the reasoning ability of an AI agent. The AI agents' reasoning ability and overall performance for out-of-domain (OOD) tasks remain unsatisfying.

### BRIEF DESCRIPTION OF THE DRAWINGS

FIG. 1 is a simplified diagram illustrating a training framework according to some embodiments.

FIG. 2A illustrates an example data flow for using a large language model to generate reasoning paths related to a task request for training the large language model according to some embodiments.

FIG. 2B illustrates an example data flow for generating training data for training a large language model according to some embodiments.

FIG. 3 illustrates an example of generating a reasoning path according to some embodiments.

FIG. 4 is a simplified diagram illustrating a computing device implementing the training framework according to some embodiments.

FIG. 5 is a simplified diagram illustrating a neural network structure, according to some embodiments.

FIG. 6 is a simplified block diagram of a networked system suitable for implementing a large language model and other embodiments described herein.

FIG. 7 is an example logic flow diagram illustrating a method of training a large language model based on the training framework according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

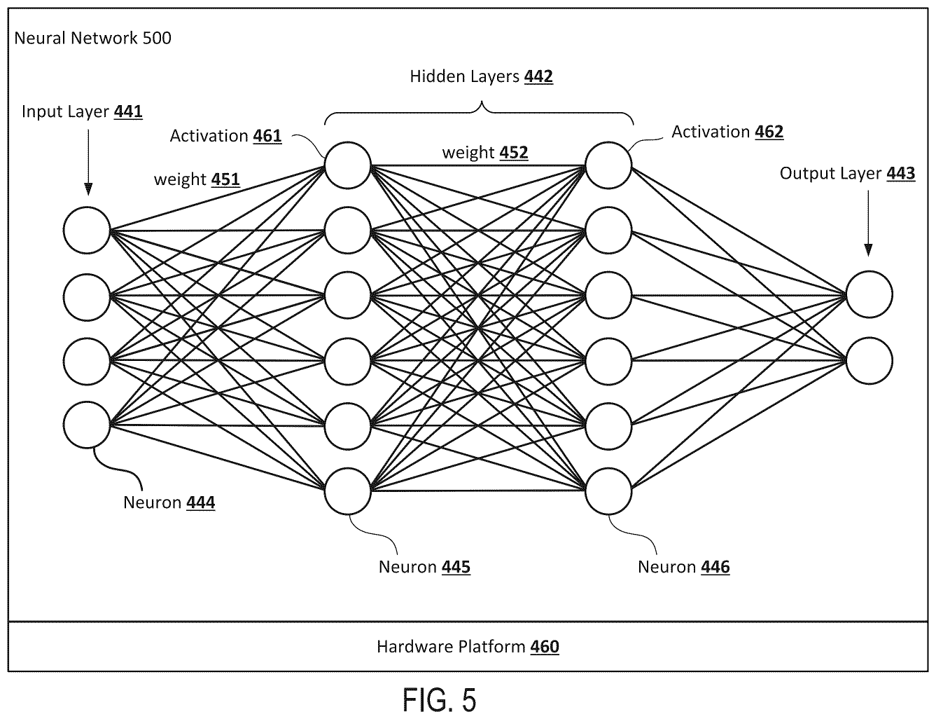

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pre-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

An LLM may generate an answer in response to an input question. In some embodiments, in addition to providing an answer to a question (e.g., solving a task request), an LLM may also be instructed (when the input combines such instruction, referred to as a “prompt,” such as “please provide the reasoning for the answer”) to generate reasoning along with the output answer. The reasoning may provide insights on how a specific answer is generated based on a specific question (e.g., related to a task or a task request). Fine-tuning the LLMs to adjust the reasoning used to generate the output answers may improve the performance of the LLMs. However, while existing solutions enable LLMs to be fine-tuned to generate correct reasoning, such fine-tuning is often limited to specific tasks, e.g., in-domain tasks. Specifically, existing fine-tuning approaches often use training data corresponding to a specific domain to train the LLM to generate correct reasoning in performing the tasks within the specific domain. Such task-specific fine-tuning can be inefficient in improving the reasoning ability of an LLM, as the LLMs' reasoning ability and overall performance for out-of-domain (OOD) tasks remain unsatisfying. As defined herein, in-domain tasks are tasks that are associated with the same domain as the training data, while out-of-domain tasks are tasks that are associated with different domains as the training data.

In view of the need for effectively training LLMs to perform tasks across different domains (e.g., both in-domain tasks and OOD tasks), embodiments described herein provides a training framework that uses LLM's self-synthesized reasoning paths to train the LLM to solve tasks in different domains. Specifically, multiple task-agnostic reasoning guidelines may be used as prompts to instruct the LLM to generate multiple reasoning paths for a training sample relating to a specific task. The different task-agnostic reasoning guidelines are not specific to the specific task, but are related to different ways of solving problems in general (e.g., different methodologies, different logics, different ways of thinking, etc.). As such, the LLM may generate different reasoning paths based on the different task-agnostic reasoning guidelines. In some embodiments, each reasoning path includes one or more task-specific steps for solving the task, and is generated through a progression of abstract-to-concrete task-specific reasoning guidelines.

For example, based on each task-agnostic reasoning guideline, the LLM may iteratively augment the guideline using information from the specific task to generate various task-specific reasoning guidelines. The LLM may iterates the augmenting process for one or more rounds, where the output from each round is more task specific than the output from the previous round, and may be used as an input for a subsequent round. The output from the last iteration may be used as a final task-specific reasoning guideline (also referred to as a “reasoning structure”) for the LLM to generate a reasoning path usable to solve the task (e.g., generate an answer for the training sample).

It is noted that not all of the task-agnostic reasoning guidelines are applicable to the specific task. As such, reasoning paths that do not result in the correct output (e.g., different from the ground truth) may be filtered out. The remaining reasoning paths are then used to generate training data for training (e.g., fine-tuning) the LLM, thereby enhancing its reasoning capabilities. Since the different reasoning paths are generated based on different task-agnostic reasoning guidelines, by training the LLM using the training data generated based on the different reasoning paths, the LLM is trained to solve the same specific task using different reasoning methodologies, which enable the LLM to improve its reasoning capabilities not just for solving tasks in the same domain as the training data, but also tasks that are different (e.g., out-of-domain tasks, etc.). Thus, using the training framework disclosed herein, the overall performance of LLMs (e.g., AI conversation agents) can be improved for both in-domain and out-of-domain tasks, even when limited training data is available.

Embodiments described herein provide a number of benefits. For example, the overall performance of an LLM in providing answers to questions across a vast number of different domains can be improved by training the LLM using the training framework disclosed herein. Specifically, the training framework enables the performance of the LLM to be improved across different domains, even when limited training data (e.g., training samples corresponding to only to one or a subset of the domains) is available. Therefore, the disclosed embodiments provide improvement to the technical field of neural network technology and AI agent.

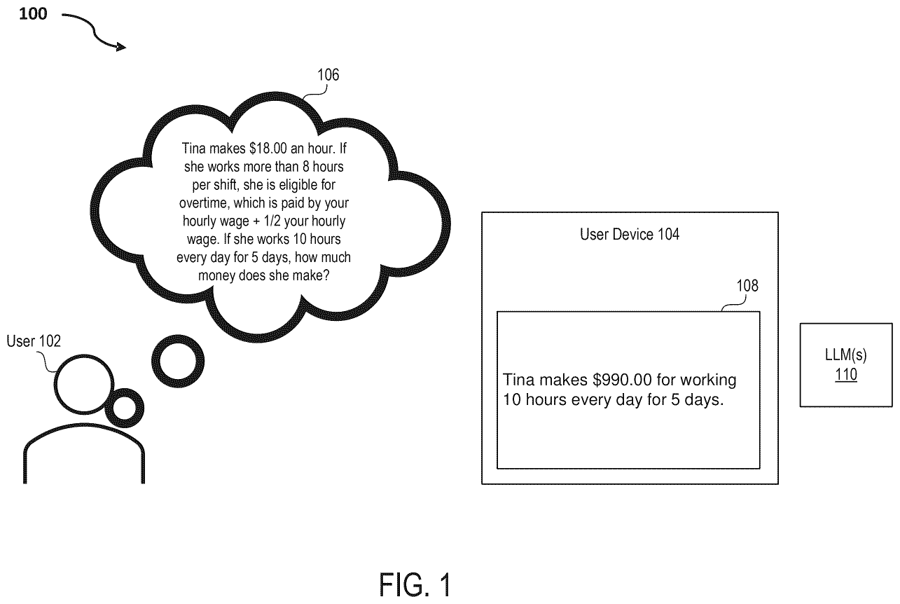

FIG. 1 shows an application 100 of an LLM based AI agent, according to embodiments of the present disclosure. A user 102 may utter a query 106 in natural language. In response, a user device 104 may output/display an answer 108 on a display interface, such as a screen. In some embodiments, answer 108 is the output of an artificial intelligence (AI) agent, which is built on a bot server that is communicatively connected to user device 104. The AI agent may be based on, or include, an LLM 110. In some embodiments, the LLM 110 receives the query 106 through an utterance of the user 102. The LLM 110 may then retrieve a corpus of documents, and generate an output based on the retrieved documents and the query 106.

As an example, the query 106 may include a question of “Tina makes $18.00 an hour. If she works more than 8 hours per shift, she is eligible for overtime, which is paid by your hourly wage+½ your hourly wage. If she works 10 hours every day for 5 days, how much money does she make?” The AI agent may include the query 106 in a predefined format providing instruction to the LLM 110 on how to generate a response to query 106, which may be referred to as a “prompt.” The AI agent may feed the prompt to the LLM 110 as input. The LLM 110 may in turn provide answer 108 based on the prompt, e.g., “Tina makes $990.00 for working 10 hours every day for 5 days.”

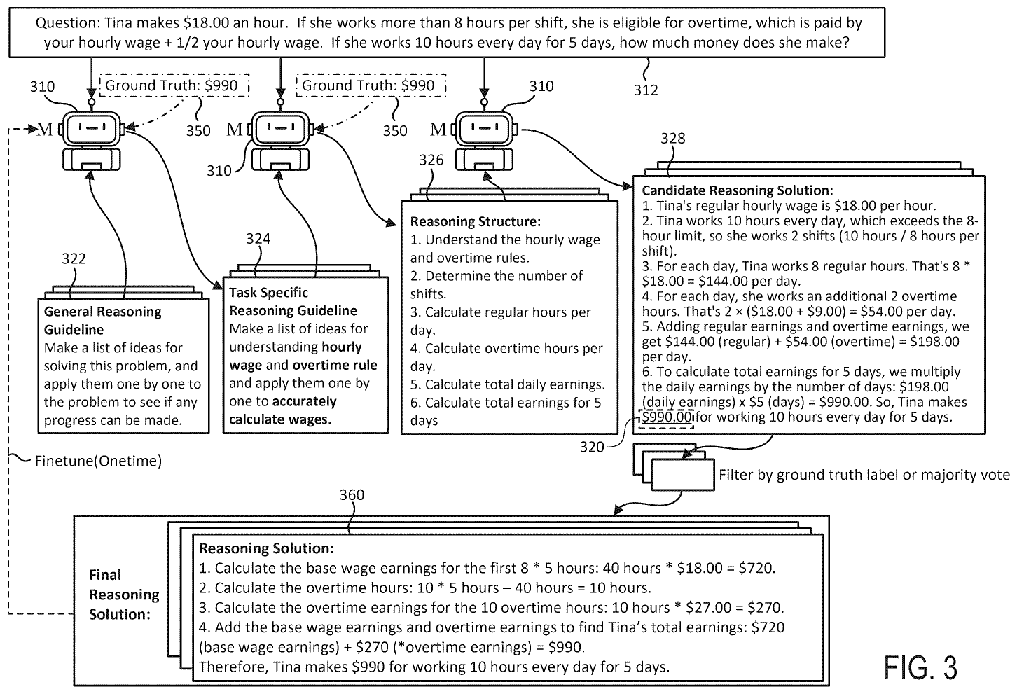

In some embodiments, for a user question such as query 106, LLM 110 may be instructed to generate a reasoning solution output explaining how the answer 108 is generated. For example, a reasoning solution (e.g., similar to the solution 328 in FIG. 3) may include a series of steps that comprises actual facts from input question 106, therefore when implemented step by step, may lead to the final answer 108.

In some embodiments, the reasoning solution may be generated by LLM 110 based on an input of the user question 106 and a reasoning structure or interchangeably referred to as “reasoning path” (e.g., 326 in FIG. 3) guiding the LLM 110 to generate the reasoning solution. For example, a reasoning structure may comprise a series of steps, each of which is applicable to actual facts from input question 106 to potentially lead to the final answer 108.

In some embodiments, a reasoning structure may be generated by the LLM 110 based on an input of a reasoning guideline. A reasoning guideline, instead of containing steps on how to arrive at answer 108, may comprise instructions and rationale for the LLM 110 to generate a series of steps (e.g., the reasoning structure) to arrive at a solution in response to a question 106. The reasoning guideline may be task-agnostic (e.g., 322 in FIG. 3) or task-specific (e.g., 324 in FIG. 3).

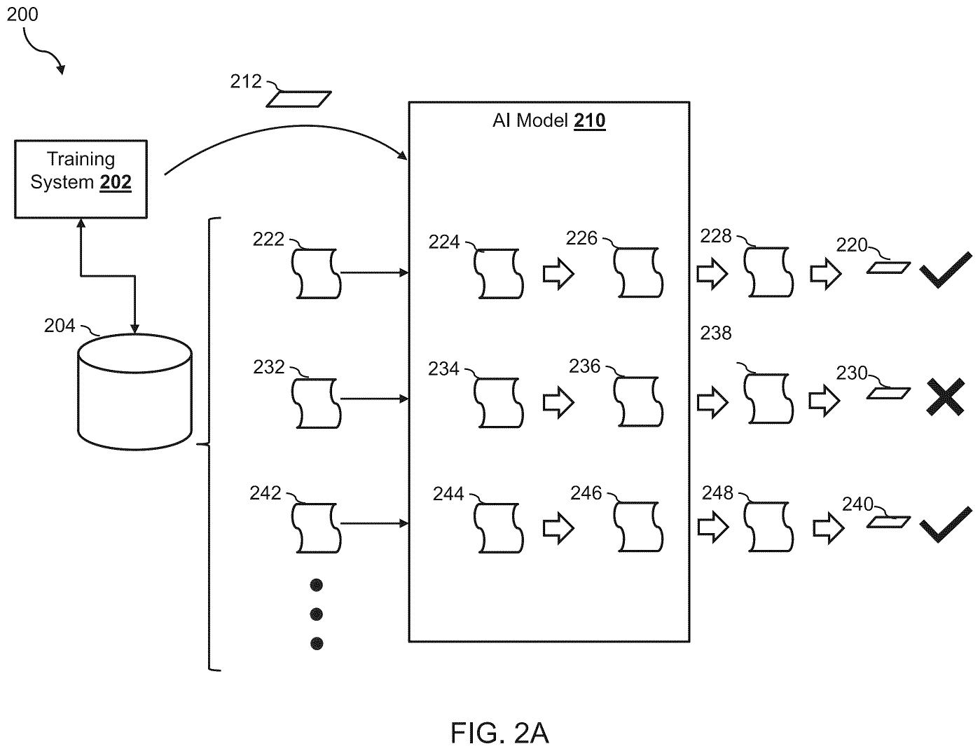

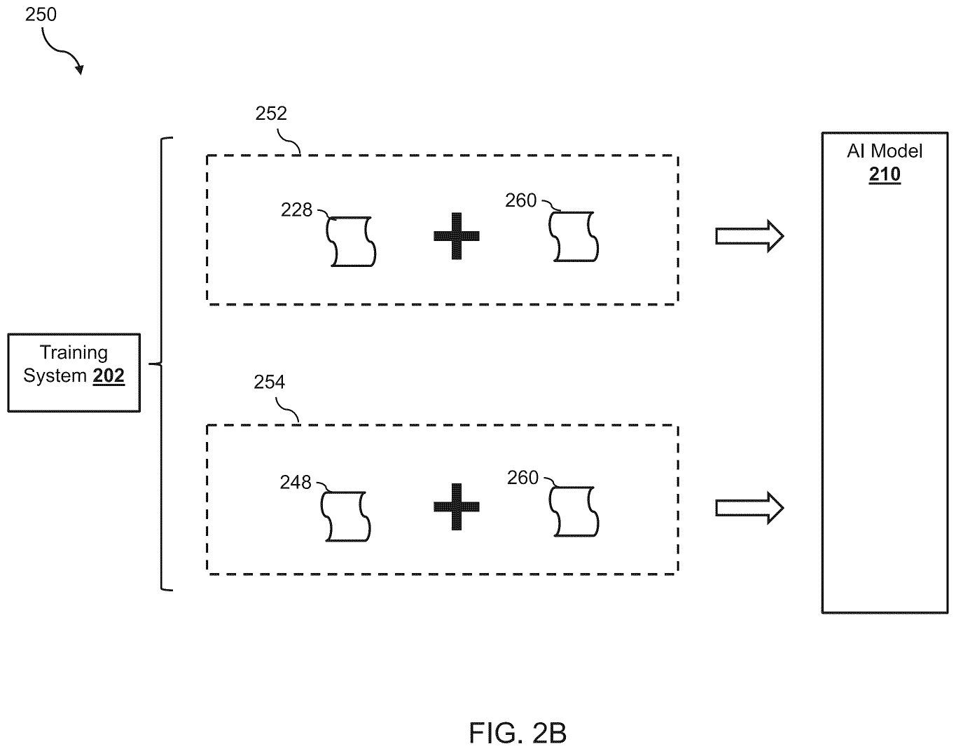

The underlying LLM 110 may be implemented at user device 104, or at a remote server which is accessible by the user device 104. In some embodiments, the LLM 110 may be trained using the training framework disclosed herein, as further described in FIGS. 2A, 2B, and 3 below.

FIG. 2A illustrates an example data flow 200 for using an LLM to generate different reasoning paths related to a task request for training the LLM according to various embodiments of the disclosure. As shown, a training system 202 is configured to use the training framework disclosed herein to train an AI model 210 to perform tasks across different domains. The AI model 210 may be implemented as an LLM, which may correspond to the LLM 110 in FIG. 1. The training system 202 is also communicatively coupled with a data storage 204 that stores training samples usable for training the AI model 210. The training samples may include task requests (e.g., in the form of questions, etc.) and corresponding solutions (e.g., in the form of answers to the questions, etc.). The AI model 210 may have been initially trained using the training samples or other training data. Through the training process, the AI model 210 may “learn” to generate the correct answers for the questions.

However, when the training data (e.g., the training samples stored in the data storage 204) that is available for training the AI model 210 is limited (e.g., below a threshold amount, corresponding to only one or a few domains, etc.), it is a challenge to train the AI model 210 to perform with satisfactory quality (e.g., able to generate correct answers to questions above a threshold percentage, etc.) across a wide range of domains. For example, when the training samples available to the training system 202 correspond to only a particular domain (e.g., mathematical problems), it is a challenge for the AI model 210 to be trained to process task requests corresponding to different domains (e.g., logical problems, common sense reasoning tasks, etc.).

As such, according to various embodiments of the disclosure, the training system 202 may train (e.g., fine-tune) the AI model 210 using self-generated reasoning paths generated by the AI model 210 according to the training framework disclosed herein. Specifically, the training system 202 may instruct the AI model 210 to generate multiple reasoning paths for each task request included in the training samples based on different task-agnostic guidelines, such as task-agnostic reasoning guidelines 222, 232, 242, etc. In some embodiments, the task-agnostic reasoning guidelines 222, 232, and 242 are not specific to any task or any domain, but specify general methodologies (e.g., strategies, logics, ways of thinking, etc.) that are applicable to a wide range of different tasks. These task-agnostic reasoning guidelines may include general descriptions on problem-solving strategies which aim at activating the AI model 210's reasoning capabilities. They are designed to be broad and applicable to a wide range of different tasks. As such, the task agnostic reasoning guidelines may specify different methodologies for solving problems (e.g., different ways for generating answers to questions, etc.). Example task-agnostic reasoning guidelines used by the training system 202 may include:
How could I devise an experiment to help solve that problem?
Make a list of ideas for solving this problem, and apply them one by one to the problem to see if any progress can be made.
How could I measure progress on this problem?
How can I simplify the problem so that it is easier to solve?
How can I break down this problem into smaller, more manageable parts?
Critical Thinking: This style involves analyzing the problem from different perspectives, questioning assumptions, and evaluating the evidence or information available. It focuses on logical reasoning, evidence-based decision-making, and identifying potential biases or flaws in thinking.
Try creative thinking, generate innovative and out-of-the-box ideas to solve the problem. Explore unconventional solutions, thinking beyond traditional boundaries, and encouraging imagination and originality.
Use systems thinking: Consider the problem as part of a larger system and understanding the interconnectedness of various elements. Focuses on identifying the underlying causes, feedback loops, and inter-dependencies that influence the problem, and developing holistic solutions that address the system as a whole.
Use Reflective Thinking: Step back from the problem, take the time for introspection and self-reflection. Examine personal biases, assumptions, and mental models that may influence problem-solving, and being open to learning from past experiences to improve future approaches.
What is the core issue or problem that needs to be addressed?
What are the potential obstacles or challenges that might arise in solving this problem?
Are there any relevant data or information that can provide insights into the problem? If yes, what data sources are available, and how can they be analyzed?
How can progress or success in solving the problem be measured or evaluated?
What indicators or metrics can be used?
Is the problem a technical or practical one that requires a specific expertise or skill set? Or is it more of a conceptual or theoretical problem?
Does the problem involve decision-making or planning, where choices need to be made under uncertainty or with competing objectives?
Is the problem an analytical one that requires data analysis, modeling, or optimization techniques?
Is the problem a design challenge that requires creative solutions and innovation?
Does the problem require addressing systemic or structural issues rather than just individual instances?
What kinds of solution typically are produced for this kind of problem specification?
Let's think step by step.
Let's make a step by step plan and implement it with good notation and explanation.
Ignoring the current best solution, create an entirely new solution to the problem.
Let's imagine the current best solution is totally wrong, what other ways are there to think about the problem specification?
What is the best way to modify this current best solution, given what you know about these kinds of problem specification?

For each task request from the training samples, the training system 202 may instruct the AI model 210 to generate different reasoning paths (e.g., reasoning paths 220, 230, 240, etc.) based on the different task-agnostic guidelines. In some embodiments, each reasoning path includes specific steps taken by the AI model 210 in solving the corresponding task request. Instead of directly instructing the AI model 210 to generate the reasoning paths, the training system 202 may instruct the AI model 210 generate the reasoning paths through a progression of various task-specific reasoning guidelines that go from an abstract scope to a concrete scope. For example, the training system 202 may instruct the AI model 210 to first convert each of the task-agnostic reasoning guidelines into one or more task-specific reasoning guidelines, which may then be used by the AI model 210 to generate the reasoning paths and the solutions.

The training system 202 may first retrieve a task request 212 and the task-agnostic reasoning guidelines 222, 232, 242, etc., from the data storage 204. The training system 202 may generate a prompt for the AI model 201 to instruct the AI model 201 to generate a first task-specific reasoning guideline for the task request 212 based on a first task-agnostic reasoning guideline (e.g., the task-agnostic reasoning guideline 222). The prompt may include instructions for instructing the AI model 210 to generate a task-specific reasoning guideline without actually solving the task request, the task-agnostic reasoning guideline, and a description of the task request. An example prompt generated by the training system 202 for the AI model 210 may include “Without working out the solution, adapt the following reasoning module to be specific to our task. Reasoning Module: {Make a list of ideas for solving this problem, and apply them one by one to the problem to see if any progress can be made.} Task: {Tina makes $18.00 an hour. If she works more than 8 hours per shift, she is eligible for overtime, which is paid by your hourly wage+½ your hourly wage. If she works 10 hours every day for 5 days, how much money does she make?}.

Based on the prompt, the AI model 210 may generate a task-specific reasoning guideline 224. The task-specific reasoning guideline 224 is specific to the task request 212. In some embodiments, the AI model 210 generates the task-specific reasoning guideline by augmenting the task-agnostic reasoning guideline using information from the task request 212. For example, the task-specific reasoning guideline 224 may include “Make a list of ideas for understanding hourly wage and overtime rule and apply them one by one to accurately calculate wages.” As shown, the task-specific reasoning guideline 224 is generated by incorporating information from the task request 212 (e.g., hourly wage and overtime rule, calculating wages, etc.) into the task-agnostic reasoning guideline 222.

In some embodiments, the training system 202 may iteratively instruct the AI model 210 to generate additional task-specific reasoning guidelines for the task request 212 based on the task-agnostic reasoning guideline 222. During each iteration, the training system 202 may generate a prompt that includes the task-specific reasoning guideline from the previous iteration and the task request 212, and instructions for the AI model 210 to convert the previously generated task-specific reasoning guideline to be more specific to the task request 212. As such, each task-specific reasoning guideline in the current iteration may be more specific to the task request 212 (e.g., include more information and/or specific steps in solving the task request 212, etc.) than the task-specific reasoning guideline in the previous iteration.

During the last iteration, the training system 202 may instruct the AI model 210 to generate a reasoning structure for solving the task request 212. A reasoning structure is different from the previously generated task-specific reasoning guideline in that it includes specific steps that can be taken by the AI model 210 to solve the task. The reasoning structure may be generated by converting the previous task-specific reasoning guideline (e.g., the task-specific reasoning guideline 224) into a more detailed framework without solving the task. It serves as a thinking principle, bridging the gap between the task-agnostic reasoning guideline 222 and the detailed reasoning path necessary to complete the task.

An example of a prompt for instructing the AI model 210 to generate the reasoning structure may include “Without working out the solution, create an actionable and concise reasoning structure step by step for the task using this adapted reasoning module: Adapted Reasoning Module {Make a list of ideas for understanding hourly wage and overtime rule and apply them one by one to accurately calculate wages.} Task {Tina makes $18.00 an hour. If she works more than 8 hours per shift, she is eligible for overtime, which is paid by your hourly wage+½ your hourly wage. If she works 10 hours every day for 5 days, how much money does she make?}. Based on the prompt, the AI model 210 may generate a reasoning structure 226.

In this example, the reasoning structure 226 generated for the task request 212 may include “1. Understand the hourly wage and overtime rules. 2. Determine the number of shifts. 3. Calculate regular hours per day. 4. Calculate overtime hours per day. 5. Calculate total daily earnings. 6. Calculate total earnings for 5 days.” The reasoning structure 226 includes a framework (e.g., step-by-step template instructions) for solving the task request 212, without actually solving the task request 212. Such detailed step-by-step instructions may enable the AI model 210 to generate a detailed reasoning path that can be used to directly solve the task request according to the methodology corresponding to the task-agnostic reasoning guideline 222.

In some embodiments, the training system 202 also instructs that AI model 210 to generate a reasoning path 228 and a solution 220 for the task request 212 (e.g., an answer to task request, etc.) according to the reasoning structure 226. For example, the training system 202 may generate a prompt for the AI model 210, such as “Using the following reasoning structure: Reasoning Structure {1. Understand the hourly wage and overtime rules. 2. Determine the number of shifts. 3. Calculate regular hours per day. 4. Calculate overtime hours per day. 5. Calculate total daily earnings. 6. Calculate total earnings for 5 days} Task {Tina makes $18.00 an hour. If she works more than 8 hours per shift, she is eligible for overtime, which is paid by your hourly wage+½ your hourly wage. If she works 10 hours every day for 5 days, how much money does she make?} Solve this task step by step based on the above reasoning structure.”

Based on the prompt, the AI model 210 may generate the solution 220, and also the reasoning path 228 used by the AI model to generate the solution 220 according to the reasoning structure 226. The reasoning path specifies the steps taken by the AI model 210 in generating the solution 220 based on the reasoning structure 226. For example, the reasoning path 228 may include the steps of “1. Tina's regular hourly wage is $18.00 per hour. 2. Tina works 10 hours every day, which exceeds the 8-hour limit, so she works 2 shifts (10 hours/8 hours per shift). 3. For each day, Tina works 8 regular hours. That's 8*$18.00=$144.00 per day. 4. For each day, she works an additional 2 overtime hours. That's 2×($18.00+$9.00)=$54.00 per day. 5. Adding regular earnings and overtime earnings, we get $144.00 (regular)+$54.00 (overtime)=$198.00 per day. 6. To calculate total earnings for 5 days, we multiply the daily earnings by the number of days: $198.00 (daily earnings)×$5 (days)=$990.00.” The solution 220 may include “Tina makes $990.00 for working 10 hours every day for 5 days.”

The sequence of task-specific reasoning guidelines generated by the AI model 210 based on the task-agnostic reasoning guideline 222 enables the AI model 210 to generate the reasoning path 228. The reasoning path 228 is the result of the AI model 210 applying the methodology corresponding to the task-agnostic reasoning guideline 222 to the specific task request 212.

The training system 202 may instruct the AI model 210 to generate different reasoning paths (e.g., reasoning paths 238, 248, etc.) for the same task request 212 based on different task-agnostic reasoning guidelines (e.g., task-agnostic reasoning guidelines 232, 242, etc.) using the same process discussed above. As such, the training system 202 may select another task-agnostic reasoning guideline (e.g., the task-agnostic reasoning guideline 232) from the data storage 204, and may instruct the AI model 210 to generate the reasoning path 238 and a solution 230 for the task request 212 based on the task-agnostic reasoning guideline 232. The training system 202 may generate prompts (similar to the prompts described above) based on the task-agnostic reasoning guideline 232 and provide the prompts to the AI model 210. Based on the prompts provided by the training system 202, the AI model 210 may generate a task-specific reasoning guideline 234 and a reasoning structure 236 sequentially. The AI model 210 may then generate a reasoning path 238 based on the reasoning structure 236, and arrive at the solution 230 according to the reasoning path 238.

The training system 202 may also select another task-agnostic reasoning guideline (e.g., the task-agnostic reasoning guideline 242) from the data storage 204, and may instruct the AI model 210 to generate another reasoning path 248 and a solution 240 for the task request 212 based on the task-agnostic reasoning guideline 242. Based on the prompts provided by the training system 202, the AI model 210 may generate a task-specific reasoning guideline 244 and a reasoning structure 246 sequentially. The AI model 210 may then generate a reasoning path 248 based on the reasoning structure 246, and arrive at the solution 240 according to the reasoning path 248.

Each of the reasoning paths 228, 238, and 248 may include step-by-step instructions for solving the task request 212 according to different methodologies used by the AI model 210. Based on the different reasoning paths 228, 238, and 248, the AI model 210 may generate the solutions 220, 230, and 240 for the task request 212. In some embodiments, the training system 202 uses at least some of the reasoning paths 228, 238, 248, etc. generated by the AI model 210 to train (e.g., fine-tune) the AI model 210. Using the different reasoning paths to train the AI model 210 enables the AI model 210 to improve its reasoning capabilities not only for in-domain tasks, but also out-of-domain tasks since the AI model 210 is trained to use different methodologies, which can be widely applicable to different types of problems, (instead of a single methodology that is applicable to in-domain task) to attack problems.

It has been contemplated that not all reasoning paths are equally suitable for solving the task request 212. For example, even though the task-agnostic reasoning guidelines are designed to be widely applicable to different problem types, not all of them are useful in solving the specific task request 212. As such, in some embodiments, the training system 202 analyzes the solutions 220, 230, 240, etc., and filters out one or more reasoning paths based on one or more factors, such as whether the solution corresponds to a ground truth or by a majority vote. For example, the training system 202 may determine if any of the solutions corresponds to a benchmark solution (e.g., a ground truth, such as an answer to the task request 212 included in the training samples). Since some of the task-agnostic reasoning guidelines are not suitable for the specific task request 212, one or more reasoning paths generated based on these task-agnostic reasoning guidelines may cause the AI model 210 to produce an incorrect answer that deviates from the benchmark solution. As such, if the training system 202 determines that a solution does not correspond to the benchmark solution or does not align with the majority of the solutions generated by the AI model 210, the training system may filter out (e.g., eliminate) the reasoning path corresponding to the solution. In this example, the training system 202 may determine that the solution 230 does not correspond to the benchmark solution. Thus, the training system 202 may filter out the reasoning path 238 corresponding to the solution 230.

If the training system 202 determines that none of the solutions generated by the AI model 210 corresponds to the benchmark solution, the training system 202 may perform the same process again by instructing the AI model 210 to generate the task-specific guidelines, the reasoning structures, the reasoning paths, and the solutions, but including the benchmark solution (e.g., the ground truth) in the prompts as a hint during each iteration of generating the task-specific reasoning guideline. An example prompt that includes the benchmark solution as a hint may include “Without working out the solution: {$990}, adapt the following reasoning modules to be specific to our task. Reasoning Module {Make a list of ideas for solving this problem, and apply them one by one to the problem to see if any progress can be made.} Task {Tina makes $18.00 an hour. If she works more than 8 hours per shift, she is eligible for overtime, which is paid by your hourly wage+½ your hourly wage. If she works 10 hours every day for 5 days, how much money does she make?}.” An example prompt for instructing the AI model 210 for generating the reasoning structure that includes the benchmark solution as a hint may include “Without working out the solution: {$990}, create an actionable and concise reasoning structure step by step for the task using this adapted reasoning module. Reasoning Module {Make a list of ideas for understanding hourly wage and overtime rule and apply them one by one to accurately calculate wages.} Task {Tina makes $18.00 an hour. If she works more than 8 hours per shift, she is eligible for overtime, which is paid by your hourly wage+½ your hourly wage. If she works 10 hours every day for 5 days, how much money does she make?}.”

FIG. 2B illustrates an example data flow 250 for generating training data for training (e.g., fine-tuning) the AI model 210 according to various embodiments of the disclosure. After filtering out undesirable reasoning paths, the training system 202 may generate training data using the remaining reasoning paths generated by the AI model 210. In this example, the training system 202 may determine that the solutions 220 and 240, but not the solution 230, correspond to the benchmark solution. As such, the training system 202 may generate training data based on the reasoning paths 228 and 248. For example, the training system 202 may generate a training data set 252 based on the reasoning path 228. The training data set 252 may include the reasoning path 228 and a benchmark solution 260 (e.g., a ground truth associated with the task request 212 from the training sample). The training system 202 may also generate a training data set 254 based on the reasoning path 248. The training data set 254 may include the reasoning path 248 and the benchmark solution 260. The training system may then train (e.g., fine-tune) the AI model 210 using the training datasets 252 and 254.

In some embodiments, the training system 202 uses the same process to generate training data for different task requests stored in the data storage 204, and train the AI model 210 using the training data. Using multiple training data sets that correspond to the same task requests to train the AI model 210, the AI model 210 is trained to adapt different methodologies corresponding to the different reasoning paths in solving the same tasks. Such a training technique enables the AI model 210 to be more adaptive, which enables the AI model 210 to be more capable of solving problems not only for in-domain tasks, but also for out-of-domain tasks, even when the training samples are limited.

FIG. 3 illustrates a specific example of generating a reasoning path according to various embodiments of the disclosure. As shown, a task request 312 which includes a question “Tina makes $18.00 an hour. If she works more than 8 hours per shift, she is eligible for overtime, which is paid by your hourly wage+½ your hourly wage. If she works 10 hours every day for 5 days, how much money does she make?” along with a task-agnostic reasoning guideline 322 are provided to the AI model 310 (e.g., in the form of a prompt). The task-agnostic reasoning guideline 322 indicates a particular general strategy for solving problems, but is not specific to the task 312. In this example, the task agnostic reasoning guideline 322 includes “Make a list of ideas for solving this problem, and apply them one by one to the problem to see if any progress can be made.” The ground truth 350, which indicates an answer to the question in the task request 312 may also be provided as a hint in the prompt.

Based on the task request 312 and the task-agnostic reasoning guideline 322, the AI model 310 may generate a task-specific reasoning guideline 324. The task-specific reasoning guideline 324 may be generated by augmenting the task-agnostic reasoning guideline 322 using information from the task request 312. In this example, the task-specific reasoning guideline 324 generated by the AI model 310 includes “Make a list of ideas for understanding hourly wage and overtime rule and apply them one by one to accurately calculate wages.”

The task-specific reasoning guideline 324 may then be provided to the AI model 310, along with the task request 312 and optionally the ground truth 350. Based on the task request 312 and the task-specific reasoning guideline 324, the AI model 310 may generate a reasoning structure 326. The reasoning structure 326 specifies a step-by-step template framework for solving the task request 312 without actually solving the task request 312.

The reasoning structure 326 may be provided to the AI model 310, along with the task request 312. Based on the task request 312 and the reasoning structure 326, the AI model 310 may generate a reasoning path 328 that specifies the step-by-step reasoning taken by the AI model 310 in arriving at the solution 320.

Using different task-agnostic reasoning guidelines (each specifying a different methodology for solving problems), the AI model 310 may generate different reasoning paths via different task-specific reasoning guidelines and reasoning structures. The reasoning paths may be filtered (e.g., reasoning paths that do not result in the correct solution may be filtered out), and the remaining reasoning paths may be used to generate training data for training the AI model 310.

### Computer and Network Environment

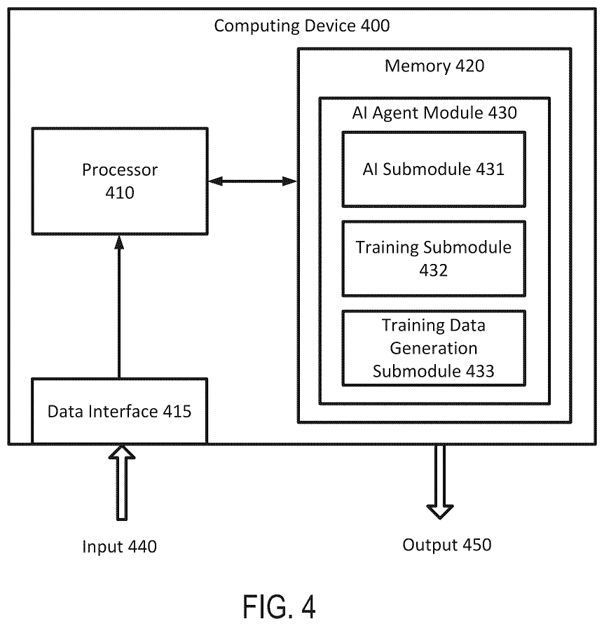

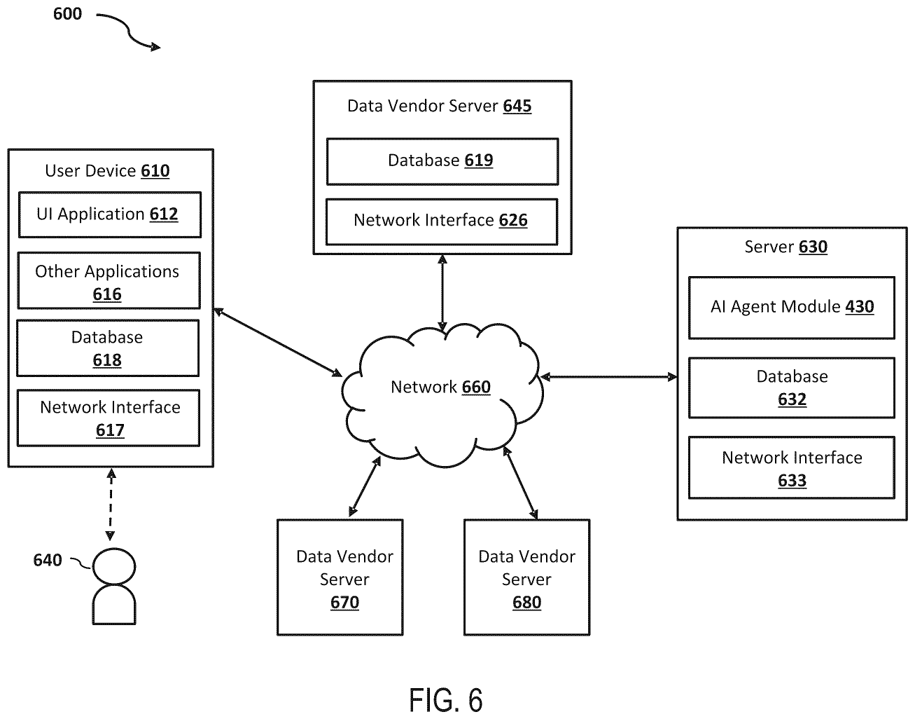

FIG. 4 is a simplified diagram illustrating a computing device implementing a conversation module described in FIG. 6, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 5.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for an AI agent module 430 that may be used to implement and/or emulate the systems and models, and/or to implement any of the methods described further herein. The AI agent module 430 may receive input 440 such as an input training data (e.g., the training samples stored in the data storage 204) or a task request (e.g., the task request 212, the task request 312, etc.) via the data interface 415 and generate an output 450 which may be an answer to a task request.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a task request, from a user via the user interface.

In some embodiments, the AI agent module 430 is configured to train and utilize a large language model to solve different task requests. The AI agent module 430 may further include an AI submodule 431 (which may correspond to the AI model 210 of FIGS. 2A and 2B, and AI model 310 of FIG. 3, etc.). For example, the AI submodule 431 may comprise a Transformer-based language model, which is described in FIG. 5.

The AI submodule 431 may be configured to solve task requests (e.g., generating answers to questions) across different domains.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating a neural network 500, which may be used to implement the AI submodule 431 described in FIG. 4, according to some embodiments. In some embodiments, the AI submodule 431 may be implemented at least partially via an artificial neural network 500 shown in FIG. 5. The neural network 500 comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., the input 440 in FIG. 4), such as a task request or a training dataset. The number of nodes (neurons) in the input layer 441 may be determined by the dimensionality of the input data (e.g., the length of a vector of a task request). Each node in the input layer represents a feature or attribute of the input.

The hidden layers 442 are intermediate layers between the input and output layers of a neural network. It is noted that two hidden layers 442 are shown in FIG. 5 for illustrative purpose only, and any number of hidden layers may be utilized in a neural network structure. Hidden layers 442 may extract and transform the input data through a series of weighted computations and activation functions.

For example, as discussed in FIG. 4, the AI agent module 430 receives an input 440 of a task request and transforms the input into an output 450 of an answer. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the AI agent module 430 and/or the AI submodule 431 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a convolutional neural network, and/or the like.

In one embodiment, the AI agent module 430 and or the AI submodule 431 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110) may receive a natural language input (such as a question) and generate a natural language output (such as an answer to the question).

In one embodiment, the AI agent module 430 and its submodules 431-433 may be implemented by hardware, software and/or a combination thereof. For example, the AI agent module 430 and its submodules 431-433 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the AI agent module 430 and its submodules 431-433 and/or any other neural network models such as the AI model 210 described in FIG. 2A and the AI model 310 described in FIG. 3 onto hardware platform 460, the neural network based modules 430 and its submodules 431-433 may be optimized for deployment by converting it to a suitable format, such as ONNX or TensorRT, to improve performance and compatibility. Next, depending on the size and workload requirements for modules 430 and its submodules 431-433, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the AI agent module 430 and its submodules 431-433 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the AI agent module 430 and its submodules 431-433 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the AI agent module 430 and its submodules 431-433 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the AI agent module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based AI agent module 430 and one or more of its submodules 431-433 may be trained by iteratively updating the underlying parameters (e.g., weights 451, 452, etc., bias parameters and/or coefficients in the activation functions 461, 462 associated with neurons) of the neural network based on a loss. For example, during forward propagation, the training data such as a task request is fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as an answer to a corresponding question) from the training data, to compute a loss function that measures the discrepancy between the predicted output and the expected output. For example, the loss function may be a cross entropy, MMSE. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based AI agent module 430 and one or more of its submodules 431-433 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

In some embodiments, the AI agent module 430 and its submodules 431-433 may be housed at a centralized server (e.g., computing device 400) or one or more distributed servers. For example, one or more of the AI agent module 430 and its submodules 431-433 may be housed at external server(s). The different modules may be communicatively coupled by building one or more connections through application programming interfaces (APIs) for each respective module. Additional network environment for the distributed servers hosting different modules and/or submodules may be discussed in FIG. 6.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as answering mathematical questions, answering logic questions, etc.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in improving the capability of solving problems across a wide range of domains using limited training samples.

FIG. 6 is a simplified block diagram of a networked system 600 suitable for implementing the training framework and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating an answer to a question from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the AI agent module 430 (which may be implemented as an LLM agent or include an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which AI agent module 430 may generate a response. The AI agent module 430 may thus cause a display of an answer at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including the data samples stored in the data storage 204 to the server 630. The database 619 may be implemented by one or more relational database, distributed databases, cloud databases, and/or the like.

The data vendor server Y645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the AI agent module 430 and its submodules described in FIG. 4. In some implementations, the AI agent module 430 may receive data from database 619 at the data vendor server 645 via the network 660 to generate training datasets.

The database 632 may be stored in a transitory and/or non-transitory memory of the server 630. In one implementation, the database 632 may store data obtained from the data vendor server 645. In one implementation, the database 632 may store parameters of the AI agent module 430.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

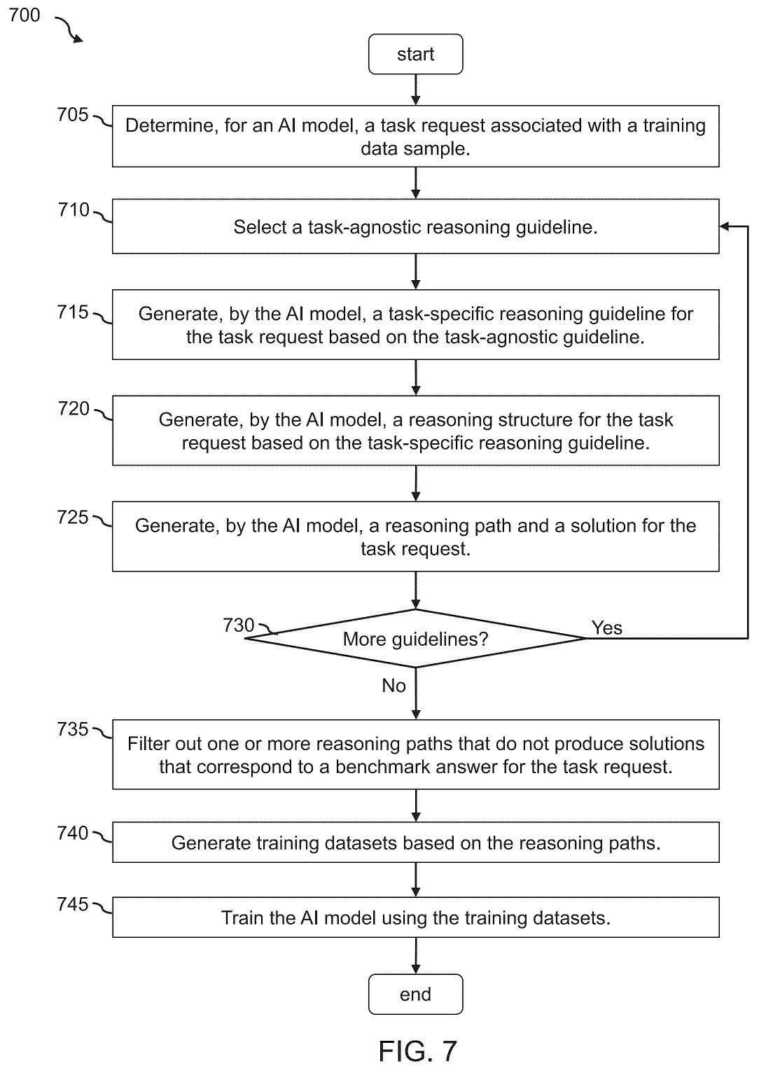

FIG. 7 is an example logic flow diagram illustrating a method 700 of training a large language module based on the training framework according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the AI agent module 430 and/or the training system 202 that trains large language models using the training techniques described herein.

In some embodiments, method 700 is performed by a system such as computing device 400, user device 610, server 630, or another device or combination of devices. Inputs (e.g., a task request) may be received via a data interface such as data interface 415, network interface 617, network interface 633, or via a data interface that is integrated with a device. For example, UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 705, a training system (e.g., the training system 202 described in FIG. 2A, etc.) determine, for an AI model (e.g., the AI model 210 described in FIGS. 2A and 2B, etc.) a task request associated with a training data sample. For example, the training system 202 may retrieve the task request 212 from the data storage 204. The data storage 204 may store training data sample that includes task requests and solutions corresponding to the task requests. In some embodiments, the data storage 204 may also store different task-agnostic reasoning guidelines that can be used by the AI model 210 to generate different reasoning paths for solving the task requests.

At step 710, the training system then selects a task-agnostic reasoning guideline. For example, the training system 202 may retrieve, from the task-agnostic reasoning guidelines stored in the data storage 204, a particular task-agnostic reasoning guideline (e.g., the task-agnostic reasoning guideline 222).

Based on the task request and the task-agnostic reasoning guideline, the AI model generates (at step 715) a task-specific reasoning guideline. For example, the AI model 210 may generate the task-specific reasoning guideline 224 by augmenting the task-agnostic reasoning guideline 222 using information from the task request 212.

The AI model then generates (at step 720) a reasoning structure for the task request based on the task-specific reasoning guideline. For example, the AI model 210 may generate the reasoning structure 226 based on the task-specific reasoning guideline 224. The reasoning structure 226 may include a particular framework for solving the task request 212 without actually solving the task request 212.

Using the reasoning structure, the AI model generates (at step 725) a reasoning path and a solution for the task request. For example, the AI model 210 may generate a reasoning path 228 based on the reasoning structure 226. The reasoning path 228 may be generated by applying the reasoning structure 226 to the specific task request 212, such that the reasoning path 228 includes step-by-step instructions for solving the task request 212. The AI model 210 may then generate a solution (e.g., an answer) for the task request 212 by following the reasoning path 228.

At step 730, the training system determines if there are any other unused task-agnostic reasoning guidelines. If another task-agnostic reasoning guideline is unused, the training system reverts back to the step 710 and selects the unused task-agnostic reasoning guideline, and causes the AI model to generate (at step 715) another task-specific reasoning guideline based on the newly selected task-agnostic reasoning guideline, generate (at step 720) a reasoning structure based on the newly generated task-specific reasoning guideline, and generate (at step 725) a reasoning path and a solution for the same task request using the newly generated reasoning structure.

On the other hand, if all of the task-agnostic reasoning guideline has been used to generate the reasoning paths and the solutions, the training system filters out (at step 735) one or more reasoning paths that do not produce solutions that correspond to a benchmark answer for the task request. For example, the training system 202 may determine if any solutions generated by the AI model 210 do not correspond to a benchmark solution, and may eliminate the reasoning path(s) that were used by the AI model 210 to generate the incorrect solution(s).

At step 740, the training system generates training datasets based on the reasoning paths and at step 745, the training system trains the AI model using the training datasets. For example, the training system 202 may generate training datasets 252 and 254 using the reasoning paths 228 and 248 generated by the AI model 210. The training system 202 may then train (e.g., fine-tune) the AI model 210 using the training datasets 252 and 254.

In some embodiments, after training the AI model using the training framework described herein, the AI model can be used by the AI agent module 430 (e.g., as the AI submodule 431) for performing different task requests for users. For example, the AI agent module 430 may use the trained AI model to answer questions of different types submitted by the user 640 via the user device 610.

In some embodiments, method 700 is applicable in a variety of applications. For example, the task request received by a neural network model (e.g., the AI submodule 431) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 700, the neural network based artificial agent may generate a response accompany an improved reasoning output to the query in different technical fields, such as AI-assisted technology in the respective technical field in healthcare and diagnostics, education and personalized learning, software development and code assistance, content creation, autonomous system (such as autonomous driving, etc.), and/or the like.

### Example Data Experiments

Five datasets are selected for training, including mathematic, logical and common sense reasoning tasks. The training sets of these datasets are used to generate self-synthetic reasoning paths and to fine-tune the language models. The test sets are employed to evaluate the in-domain performance of the fine-tuned models.
Mathematic reasoning: GSM8K math problem dataset (Cobbe et al., 2021) and NumGLUE dataset (Mishra et al., 2022). In this experiment, only the numerical answers are used as the ground truth in the GSM8K dataset, excluding the human-provided reasoning paths. This approach enables independent evaluation of the contribution of reasoning to the overall performance.
Logical reasoning: logical reasoning dataset ReClor (Yu et al., 2020) is used.
Commonsense reasoning: AI2 Reasoning Challenge (ARC) (Clark et al., 2018) and StrategyQA (Geva et al., 2021) dataset. For ARC, only the Challenge subset (ARC-c) is used.

The main experiments are conducted using the instruction fine-tuned version of the Mistral-7B-v0.3 (Jiang et al., 2023) model, known as Mistral-7B-Instruct-v0.3. The method is also evaluated on other LLMs such as Meta-Llama-3-8B-Instruct (AI@Meta, 2024) Self-synthesized reasoning path generation is first performed. Using the Mistral-7B-Instruct-v0.3 with a temperature setting of 0.85, 25 diverse reasoning paths are generated for every instruction within the training set. Subsequently, an exact match method is employed to filter out incorrect paths by comparing the answer in the reasoning path with the ground truth. For instructions that fail to generate any correct reasoning paths in the preceding steps, the ground truth is incorporated as a hint for reasoning path generation using the same model and temperature. Finally, up to five (p=5) reasoning paths are randomly selected per question as target outputs. Therefore, final training samples are up to the size of 5×|D^{train}|, where |D^{train}| denotes the size of the training set. The final step involves fine-tuning the Mistral-7B-Instruct-v0.3 model using the generated reasoning paths, with a learning rate of 1e⁻⁶ and training for 3 epochs and a batch size of 16, utilizing an 8-GPU node of A100 GPUs, each with 40 GB of memory.

### Baselines

Base model without further fine-tuning (w/o FT). For this baseline, the performance of the base LLM, Mistral-7B-Instruct-v0.3 (Jiang et al., 2023), is reported. No further fine-tuning is performed.

Fine-Tuning with Ground Truth Only (FT w/GT). In this approach, the base LLM is fine-tuned using the original instructions and ground-truth answers in the training sets, without incorporating any self-synthesized reasoning paths.

Fine-Tuning with Self-Improvement approach (LMSI). LMSI (Huang et al., 2023) first samples self-synthesized reasoning paths using few-shot CoT prompting. These reasoning paths are then filtered by selecting the one with the majority vote answer. Finally for this baseline, the base LLM is fine-tuned using these self-generated solutions as the target outputs.

Fine-Tuning with Self-Improvement approach and ground truth (LMSI w/GT). For this baseline, the same reasoning generation process as LMSI is followed. However, instead of using a majority vote to filter out incorrect reasoning paths as above, ground truth answers are used. The base LLM is then fine-tuned using these self-generated solutions as the target outputs.

Fine-Tuning with Self-Taught Reasoner approach (STaR). STaR (Zelikman et al., 2022) begins by sampling self-synthesized reasoning paths directly using the few-shot CoT prompting. In contrast, the training framework described herein progresses from abstract to concrete reasoning without relying on CoT examples. Then, these paths are filtered based on ground truth and incorporate the ground truth as hints directly in the instructions to generate reasoning paths for instructions lacking correct solutions. Subsequently, the base LLM is fine-tuned using these self-synthesized solutions as target outputs.

### Evaluation Methods

At inference, for a fair and accurate comparison, exact match accuracy is used on all experiments. multiple prompting methods are also tested for ReGenesis and each baseline at inference. In the “CoT Prompting” method (Wei et al., 2022), the LLM models are provided with prompts with: “Solve the following problem step-by-step. Question:”+{question}+“Answer:”, using a temperature setting of 0.8. In “Self-Consistency” (Wang et al., 2022), the same prompt is used but generate 15 responses at a temperature of 0.8, then select the final answer based on majority voting.

### In-Domain Experiments

In this experimental setup, the enhancement of LLMs' in-domain reasoning capabilities using the training framework described herein is evaluated, comparing it with existing self-improvement methods. For each reasoning dataset, reasoning paths are constructed from the training sets, the model is fine-tuned based on the synthesized reasoning data, and subsequently the model's performance on the respective test sets is evaluated.

TABLE 2
Comparison of zero-shot accuracy between fine-tuned and non-fine-tuned Mistral-
7BInstruct-v0.3 models using different prompting methods. All fine-tuned models
are trained on a single training set from one dataset and evaluated on the corresponding
test set across 5 math, logical and commonsense reasoning datasets.

| Training | Prompting Method | GSM8K | NumGlue | ARC-c | ReClor | StrategyQA |
|---|---|---|---|---|---|---|
| Method\|s | at Inference | (Math) | (Math) | (Logical) | (Logical) | (Commonsense) |
| w/o FT | CoT Prompting | 44.0% | 40.6% | 77.2% | 57.6% | 77.4% |
| | Self-Consistency | 60.0% | 38.2% | 80.6% | 56.2% | 80.8% |
| FT w/ GT | CoT Prompting | 13.8% | 55.0% | 77.4% | 70.4% | 85.6% |
| | Self-Consistency | 15.2% | 55.9% | 77.2% | 71.6% | 85.6% |
| LMSI | CoT Prompting | 51.8% | 46.5% | 67.9% | 51.8% | 78.3% |
| | Self-Consistency | 62.3% | 57.1% | 71.7% | 50.8% | 79.0% |
| LMSI w/ GT | CoT Prompting | 57.4% | 51.8% | 75.9% | 58.0% | 80.2% |
| | Self-Consistency | 66.3% | 62.2% | 77.5% | 59.4% | 81.7% |
| STaR | CoT Prompting | 46.3% | 48.3% | 76.5% | 57.8% | 84.4% |
| | Self-Consistency | 66.0% | 64.5% | 84.1% | 63.8% | 85.9% |
| ReGenesis | CoT Prompting | 63.6% | 52.2% | 78.0% | 68.4% | 81.5% |
| | Self-Consistency | 76.6% | 74.7% | 85.4% | 70.6% | 91.3% |

As presented in Table 2, the model trained using the training framework disclosed herein significantly surpasses all baselines, achieving an average performance enhancement of 16.56% over the original model without fine-tuning. Baseline approaches, such as LMSI and STaR, which incorporate self-synthesized reasoning paths into their fine-tuning processes, also demonstrated improvements, albeit less significant than those achieved by the model trained using the training framework disclosed herein. This suggests that the quality or diversity of the reasoning paths generated by these models is inferior to those created by this training framework. LMSI (Huang et al., 2023) adds self-synthesized reasoning paths to the fine-tuning training set, filtering these paths through self-consistency checks. However, the lack of guaranteed accuracy in these self-consistency reasoning paths compromises data quality, leading to a modest improvement of only 1.02% in average test performance. To address this issue, a modification is implemented where ground truth is utilized for filtering (LMSI w/GT), thereby enhancing the quality of the reasoning paths. This adjustment raised the improvement from 1.02% to 6.26%. STaR (Zelikman et al., 2022) also employs ground-truth-verified reasoning paths but adopts a slightly different prompting and reasoning path format during post-training compared to LMSI, leading to a 9.7% test set improvement, which remains below our performance significantly.

During our experiments, it is noted that training solely with ground-truth answers (FT w/GT) and excluding reasoning paths does not consistently improve the performance of the base large language model (LLM), even on in-domain test sets. Specifically, in the GSM8K and ARC-C tasks, relying exclusively on ground-truth answers led to performance declines of 44.8% and 3.4%, respectively. This observation underscores the importance of incorporating reasoning paths during the fine-tuning stage to enhance the LLM's reasoning capabilities.

### Out-of-Domain Experiments

In this experiment, the fine-tuned language models are assessed on six OOD tasks. The objective is to determine whether fine-tuning with or without self-synthesized reasoning paths influences the models' general reasoning capabilities. Each model, fine-tuned on a specific task is tested across all the following six OOD tasks.
Mathematic reasoning: We use ASDIV (Miao et al., 2020), SVAMP (Patel et al., 2021) and the AQUA-RAT (Algebra Question Answering with Rationales) (Ling et al., 2017) datasets.
Logical reasoning: BIG-Bench Hard (BBH) (Suzgun et al., 2023) dataset, a subset of BIG-Bench.
Natural Language Inference (NLI): We utilize the Adversarial NLI (ANLI) (Mihaylov et al., 2018b) subsets ANLI-A2 and ANLI-A3. These subsets are more challenging than ANLI-A1 and include sentence pairs with entailment, neutral, or contradiction relations.
Commonsense Reasoning: We use OpenBookQA (Mihaylov et al., 2018a), a question-answering dataset modeled after open book exams for assessing human understanding of a subject.

### Results

TABLE 3
Zero-shot accuracy comparison between non-fine-tuned Mistral-7B-Instruct-v0.3 model
and the models finetuned on one of five in-domain datasets separately and evaluated
using the “Self-Consistency” prompting method across six out-of-domain tasks.

| | | Test Datsets | | | | | |
|---|---|---|---|---|---|---|---|
| Training | Training | ASDIV | SVAMP | AQUA | BBH | ANLI | OpenbookQA |
| Datasets | Methods | (Math) | (Math) | (Math) | (Logical) | (NLI) | (Commonsense) |
| GSM8K | w/o FT | 77.2%— | 75.4%— | 41.3%— | 60.8%— | 38.4%— | 75.6%— |
| (Math) | FT w/GT | 54.0%↓ | 40.0%↓ | 29.1%↓ | 53.6%↓ | 44.6%↑ | 72.6%↓ |
| | LMSI w/GT | 77.3%↑ | 72.2%↓ | 31.1%↓ | 59.5%↓ | 43.4%↑ | 73.2%↓ |
| | STaR | 79.6%↑ | 71.5%↓ | 46.9%↑ | 47.4%↓ | 45.0%↑ | 72.8%↓ |
| | Ours | 81.2%↑ | 83.9%↑ | 48.8%↑ | 69.3%↑ | 49.5%↑ | 81.4%↑ |
| NumGLUE | w/o FT | 77.2%— | 75.4%— | 41.3%— | 60.8%— | 38.4%— | 75.6%— |
| (Math) | FT w/GT | 53.8%↓ | 54.9%↓ | 32.3%↓ | 42.4%↓ | 37.0%↓ | 64.8%↓ |
| | LMSI w/GT | 75.7%↓ | 78.2%↑ | 40.6%↓ | 59.5%↓ | 35.1%↓ | 72.6%↓ |
| | STaR | 79.6%↑ | 76.1%↑ | 37.0%↓ | 58.5%↓ | 41.9%↑ | 71.6%↓ |
| | Ours | 76.9%↓ | 79.4%↑ | 48.4%↑ | 61.7%↑ | 50.0%↑ | 79.8%↑ |
| ReClor | w/o FT | 77.2%— | 75.4%— | 41.3%— | 60.8%— | 38.4%— | 75.6%— |
| (Logical) | FT w/GT | 62.0%↓ | 56.0%↓ | 22.0%↓ | 44.0%↓ | 47.1%↑ | 71.4%↓ |
| | LMSI w/GT | 77.9%↑ | 76.8%↑ | 45.6%↑ | 53.9%↓ | 35.1%↓ | 72.4%↓ |
| | STaR | 76.1%↓ | 74.6%↓ | 46.1%↑ | 60.6%↓ | 42.5%↑ | 77.2%↑ |
| | Ours | 76.4%↓ | 76.5%↑ | 49.6%↑ | 66.8%↑ | 44.8%↑ | 81.4%↑ |
| ARC-c | w/o FT | 77.2%— | 75.4%— | 41.3%— | 60.8%— | 38.4%— | 75.6%— |
| (Logical) | FT w/GT | 57.7%↓ | 57.2%↓ | 18.9%↓ | 37.6%↓ | 36.3%↓ | 78.4%↑ |
| | LMSI w/GT | 70.9%↓ | 72.0%↓ | 32.7%↓ | 60.8%— | 32.5%↓ | 79.4%↑ |
| | STaR | 77.0%↓ | 76.2%↑ | 40.6%↓ | 60.7%↓ | 47.4%↑ | 84.2%↑ |
| | Ours | 81.6%↑ | 79.5%↑ | 46.5%↑ | 66.0%↑ | 46.4%↑ | 82.8%↑ |
| StrategyQA | w/o FT | 77.2%— | 75.4%— | 41.3%— | 60.8%— | 38.4%— | 75.6%— |
| (Commonsense) | FT w/GT | 69.4%↓ | 72.3%↓ | 43.7%↑ | 52.3%↓ | 44.9%↑ | 62.2%↓ |
| | LMSI w/GT | 56.3%↓ | 56.8%↓ | 40.6%↓ | 60.0%↓ | 39.8%↑ | 68.4%↓ |
| | STaR | 79.8%↑ | 76.2%↑ | 43.3%↑ | 62.9%↑ | 37.3%↓ | 77.4%↑ |
| | Ours | 81.3%↑ | 81.1%↑ | 42.9%↑ | 65.9%↑ | 55.3%↑ | 80.4%↑ |

As illustrated in Table 3, the model trained using the training framework disclosed herein surpasses all baseline models in OOD tasks. Specifically, the model trained using the training framework shows a remarkable 6.1% improvement compared to the original model without finetuning. Conversely, existing methods display an average performance drop of roughly 4.6% on OOD tasks. These findings underscore the effectiveness of the training framework disclosed herein in enhancing the general reasoning capabilities of LLMs, enabling them to evolve into reasoning generalists through self-improvement.

Firstly, as shown in Table 3, fine-tuning the language model solely on ground-truth solutions (FT w/GT) significantly decrease its performance on all OOD tasks, indicating that employing reasoning paths for fine-tuning is even more important in OOD settings. Secondly, other baselines that fine-tune the language model using CoT prompted task-specific reasoning paths (LMSI w/GT, STaR) do not improve their performance across all OOD domains. Specifically, the performance fluctuations range from a decrease of 20.9% to an increase of 8.6% on these OOD tasks. It is further observed that the increase in OOD performance for such baseline methods almost only happen on OOD tasks closely relevant to its training data. For example, training on NumGLUE consistently boosts performance on SVAMP across all models that incorporate self-synthesized reasoning paths, with an average improvement of 2.5%. However, when the tasks are more OOD, performance tends to drop significantly. For example, training on NumGLUE or GSM8K leads to a consistent performance drop of approximately 3.1% on OpenBookQA and 4.6% on BBH when using the two baselines that incorporate reasoning paths, namely LMSI w/GT and STaR. In contrast, the training framework disclosed herein does not restrict the self-synthesized reasoning paths with task-specific patterns or human-designed CoT examples, leading to performance improvement in almost all OOD scenarios tested.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of generating reasoning structures for a task performed by an artificial intelligence (AI) agent, the method comprising:
obtaining, via a data interface, a task request comprising one or more task-specific facts;
generating, by a neural network-based language model of the AI agent, a plurality of reasoning paths relating to the task request based on a plurality of task-agnostic reasoning guidelines, wherein each reasoning path in the plurality of reasoning paths includes a sequence of steps that indicate a logic flow in solving the task request;
generating, by the neural network-based language model, a plurality of solutions for the task request according to the plurality of reasoning paths, wherein each of the plurality of solutions comprises the sequence of steps applied with the one or more task-specific facts thereby resulting in an answer to the task request;
generating a plurality of training datasets for training the neural network-based language model based on the plurality of reasoning paths and the plurality of solutions, wherein each training dataset in the plurality of training datasets comprises at least the task request, a corresponding reasoning path from the plurality of reasoning paths, and the answer; and
training the neural network-based language model based on the plurality of training dataset.

2. The method of claim 1, further comprising:
generating, by the neural network-based language model, a first task-specific reasoning guideline based on a first task-agnostic reasoning guideline from the plurality of task-agnostic reasoning guidelines, wherein the first task-specific reasoning guideline is generated based on augmenting the first task-agnostic reasoning guideline using information associated with the task request.

3. The method of claim 2, wherein the generating the first task-specific reasoning guideline is further based on a ground truth associated with the task request.

4. The method of claim 2, further comprising:
generating, by the neural network-based language model, a first reasoning structure based on the first task-specific reasoning guideline and the task request, wherein a first reasoning path from the plurality of reasoning paths is generated based on the first reasoning structure.

5. The method of claim 4, wherein the first reasoning structure provides a framework for solving the task request without solving the task request.

6. The method of claim 1, further comprising:
determining, from the plurality of solutions, one or more solutions that do not correspond to a benchmark solution; and
excluding one or more reasoning paths from the plurality of reasoning path that corresponds to the one or more solutions in the generating of the plurality of training datasets.

7. The method of claim 6, wherein the benchmark solution comprises a ground truth associated with the task request.

8. A system for generating reasoning structures for a task performed by an artificial intelligence (AI) agent, the system comprising:
a memory that stores a neural network-based language model associated with the AI agent and a plurality of processor executable instructions;
a communication interface that receives training data samples; and
one or more hardware processors that read and execute the plurality of processor-executable instructions from the memory to perform operations comprising:
generating, by the neural network-based language model of the AI agent, a plurality of reasoning paths relating to a task request based on a plurality of task-agnostic reasoning guidelines, wherein each reasoning path in the plurality of reasoning paths includes a sequence of steps that indicate a logic flow in solving the task request;
generating, by the neural network-based language model, a plurality of solutions for the task request according to the plurality of reasoning paths, wherein each of the plurality of solutions comprises an answer to the task request based on an application of a corresponding reasoning path from the plurality of reasoning paths to the task request;
generating a plurality of training datasets for training the neural network-based language model based on the plurality of reasoning paths and the plurality of solutions, wherein each training dataset in the plurality of training datasets comprises at least the task request, a corresponding reasoning path from the plurality of reasoning paths, and a benchmark answer; and
training the neural network-based language model based on the plurality of training dataset.

9. The system of claim 8, wherein a first training dataset in the plurality training datasets comprises a particular reasoning path for solving the task request, and wherein the training the neural network-based language model comprises adjusting a series of reasoning steps used by the neural network-based language model to solve the task request according to the particular reasoning path.

10. The system of claim 8, wherein the operations further comprise:
receiving a question from a user device;
generating, by the trained neural-network-based language model, an answer to the question; and
providing the answer to the user device.

11. The system of claim 8, wherein the operations further comprise:
determining, from the plurality of solutions, one or more solutions that do not correspond to a benchmark solution; and
excluding one or more reasoning paths from the plurality of reasoning path that corresponds to the one or more solutions in the generating of the plurality of training datasets.

12. The system of claim 11, wherein the benchmark solution corresponds to a common solution shared by a portion of the plurality of solutions.

13. The system of claim 8, wherein the operations further comprise:
generating, by the neural network-based language model, a first task-specific reasoning guideline based on a first task-agnostic reasoning guideline from the plurality of task-agnostic reasoning guidelines, wherein the first task-specific reasoning guideline is generated based on augmenting the first task-agnostic reasoning guideline using information associated with the task request.

14. The system of claim 13, wherein the operations further comprise:
generating, by the neural network-based language model, a first reasoning structure based on the first task-specific reasoning guideline and the task request, wherein a first reasoning path from the plurality of reasoning paths is generated based on the first reasoning structure.

15. A non-transitory machine-readable medium comprising a plurality of machine-executable instructions which, when executed by one or more processors, are adapted to cause the one or more processors to perform operations comprising:
generating, by a neural network-based language model of the AI agent, a plurality of reasoning paths relating to a task request based on a plurality of task-agnostic reasoning guidelines, wherein each reasoning path in the plurality of reasoning paths includes a sequence of steps that indicate a logic flow in solving the task request;
generating, by the neural network-based language model, a plurality of solutions for the task request according to the plurality of reasoning paths, wherein each of the plurality of solutions comprises an answer to the task request based on an application of a corresponding reasoning path from the plurality of reasoning paths to the task request;
generating a plurality of training datasets for training the neural network-based language model based on the plurality of reasoning paths and the plurality of solutions, wherein each training dataset in the plurality of training datasets comprises at least the task request, a corresponding reasoning path from the plurality of reasoning paths, and a benchmark answer; and
training the neural network-based language model based on the plurality of training dataset.

16. The non-transitory machine-readable medium of claim 15, wherein the operations further comprise:
receiving a task query from a user device;
generating, by the trained neural-network-based language model, an answer to the task query; and
providing the answer to the user device.

17. The non-transitory machine-readable medium of claim 16, wherein the operations further comprise:
generating by at least one Application-Specific Integrated Circuit (ASIC) performing a multiplicative and/or accumulative operation for the neural network-based language model, a next token; and
generating a natural language output representing the answer to the task query based on combining a sequence of generated tokens.

18. The non-transitory machine-readable medium of claim 16, wherein the task query includes a query to identify an information technology (IT) anomaly relating to a usage of an IT component, and wherein the operations further comprise:
determining, based on the answer, that an updated action execution state representing an information technology anomaly; and
causing an alert relating to the information technology anomaly to be displayed at a visualized user interface of the user device.

19. The non-transitory machine-readable medium of claim 15, wherein the operations further comprise:
generating, by the neural network-based language model, a first task-specific reasoning guideline based on a first task-agnostic reasoning guideline from the plurality of task-agnostic reasoning guidelines, wherein the first task-specific reasoning guideline is generated based on augmenting the first task-agnostic reasoning guideline using information associated with the task request.

20. The non-transitory machine-readable medium of claim 15, wherein the operations further comprise:
generating, by the neural network-based language model, a first reasoning structure based on the first task-specific reasoning guideline and the task request, wherein a first reasoning path from the plurality of reasoning paths is generated based on the first reasoning structure.
